(19) United States
(12) Patent Application Publication
(10) Pub. No.: US 2006/0140058 A1
(43) Pub. Date: Jun. 29, 2006

(54) Method for integrating at least one electronic module in or on the glass of a watch and watch glass obtained by such a method

(76) Inventors: Alex Kalbermatten, Sion (CH); Gianni D'Onghia, Uvrier (CH); Jean-Pierre Kalbermatten, Saviese (CH)

Correspondence Address: BLANK ROME LLP, 600 NEW HAMPSHIRE AVENUE, N.W., WASHINGTON, DC, 20037, US

(21) Appl. No.: 11/257,653

(22) Filed: Oct. 21, 2005

Related U.S. Application Data
(63) Continuation of application No. PCT/CH04/00649, filed on Oct. 28, 2004.

(30) Foreign Application Priority Data
Apr. 24, 2004 (CH) CH711/04

(51) Int. Cl. G04C 11/02; G04B 39/00; G04B 37/00

(52) U.S. Cl. 368/47; 368/296

(57) ABSTRACT

The invention relates to the Integration method of at least one electronic module (1) in or on the glass (3) on watches, generally wristwatches, by means of a non-solid solution (4). The electronic module (1) is injected or positioned with a non-solid solution (4) in a cavity hole (2) in the glass (3), provided for housing the same, or on a part of the surface of the glass (3). The electronic module is perfectly integrated and/or fixed within or on the glass (3), in particular, as a result of the epoxide characteristics and the transparent vitrification of the solution (4).

### REFERENCE DATA

This application is a continuation of International Patent Application PCT/CH2004/000649 (WO2005/064421) filed on Oct. 28, 2004, claiming priority of Swiss patent application CH711/04 of Apr. 24, 2004, the contents whereof are hereby incorporated.

### FIELD OF THE INVENTION

The present invention relates to the method for integrating at least one electronic module in or on the glass of a watch, as well as a watch glass obtained by such a method.

### DESCRIPTION OF RELATED ART

It is well-known to equip watches, generally wristwatches, with such electronic modules for the memorizing of information consisting of an integrated circuit chip connected to an antenna and which can communicate by radio signals with an external reading and/or writing device. These electronic modules, commonly called transponder or tag, are often of passive type, energy being provided to them by radio frequencies emitted by the reader. According to various modes of realization known, the electronic module is integrated either in the bezel, in the case-bezel, under the dial, in the watch case, on or in the lid of the back of the watch case, in the body of control as the crown, or in the wristband of the watch. The idea to integrate such electronic modules in the watch being to use the progresses obtained in the field of radio frequency identification(RFID) systems, in order to improve protection of the watch and of its components against imitations or counterfeits, or allowing it followed watch throughout its life to use the data at ends of quality control, after-sales and guarantee services, stock management, or publicity and marketing, or offering developments and applications not relating to the watch, such as for example the access control or the identity control of the wearer of the watch.

By the disclosures of the patents CH692069A5 and CH689360A5, it is also known to equip a watch glass with a microchip connected to an antenna, intended to transmit to an external reader the information contained in the microchip. Nevertheless, none of the disclosures known to date offer a method which solves perfectly and precisely the integration of the aforesaid electronic module in or on the glass of a watch. Within sight of the specific characteristics of the watch glasses commonly used, in particular those used of preference for luxury watches, which are often made out of mineral glass for the profit of organic glass, it is advisable to find a method for integrating the electronic module, adapted to specificities of a support such as for example the transparent crystalline hard material of the family of corundum, such as sapphire or spinel, but without deteriorating its physical, technical, material, optical, visual or of transparency appearance. Moreover, within sight of constant miniaturization of the electronic modules, their handling and their integration become increasingly complicated with the techniques currently known in the embodiment and their fixing. It is thus advisable to solve also this problem there. We know that currently already, there are electronic modules available on the market, that have an equal or lower size to 0.4 mm2 and that soon already will be smaller than the tenth of a millimeter, and will not be any more visible or visible with much difficulty with the naked eye, their handling for an adequate integration in the glass of a watch thus poses a technical problem, which cannot be solved any more by the means of integration commonly used to date and which touches very quickly to their limits, while not giving more of the satisfactory results. The present invention fills these gaps in the way defined in the claims.

The object of the invention aims to solve the above-mentioned problems and consists in presenting a solution adapted to integrate electronic modules in a wristwatch, and more particularly in or on the glass of a watch, without deteriorating, or of less than one not very important manner, the characteristics of the aforesaid electronic modules as well as the specificities of the glasses made on crystalline, mineral or organic material.

The goal of the present invention not only consists in overcoming specificities regarding to the mineral or organic glasses, but also to facilitate and to solve the integration, the embodiment, the incorporation, the fixing, the vitrification and the sealing of an electronic module in or on the glass of a watch.

For reasons of clearness, we decided that the term of “electronic module” was sufficient with the comprehension of our solution, and not to use systematically a term of “electronic nano-module” for example, although its very small current dimension and its potential of future miniaturization, would intend it to be precisely entitled with a “nano-” prefix.

### BRIEF SUMMARY OF THE INVENTION

To achieve this objective, the method is to apply the electronic module with a solution that is liquid, semi-solid or gaseous, fixing it inside or outside the glass. The aforementioned solution is intended to solidify and to fix itself with the electronic module inside or outside of the glass. It will also make it possible to fill the vacuum of a cavity envisaged for this purpose.

One of the essential advantages of such a method is to be able to handle and also to fix more precisely the tiny electronic module, thanks in particular to the fact that the aforementioned module is drowned first of all in a non-solid solution and then directed, without risk to lose it, to the desired emplacement.

Another required advantage of the invention of this method is, that it can be able to be machined using simple conventional machines and tools, planned for mass production.

Moreover, the advantages brought by the mixture of certain components in the solution will allow to bring many advantages to the electronic module, namely for example, a better wear resistance, a better chemical or thermal resistance, the maintenance of large optical transparency in the watch glass or the absence of porosity.

Thanks to this method, deterioration, destruction, the extraction, or even the theft of this electronic module, for the use with other ends that those envisaged initially will be so to speak almost impossible without damaging the electronic module, or then an extraction of the aforesaid electronic module far from economic.

### BRIEF DESCRIPTION OF THE DRAWINGS

Other distinctive features, advantages and characteristics of the invention will arise more clearly from the description which will follow of a mode of realization of the invention given by way of nonrestrictive example, and represented on the additional drawings:

FIG. 1 shows in a diagrammatic view the upper or lower face of a glass comprising an electronic module perfectly integrated in or on the glass and of which the non-solid solution is merged with the glass, and in a section view to a larger scale of the glass along the axis (A-A′), where can be placed the electronic module;

FIGS. 2 and 2.1 represent an electronic module seen in a diagrammatic view and in a section view, composed of an integrated circuit chip and of an antenna;

FIG. 3 shows in a diagrammatic view the upper or lower face of a glass comprising an electronic module in its center axis, placed in a cavity with a non-solid solution as seen in a section view to a larger scale of the glass according to axis (A-A′); other alternatives of realization with an electronic module close to the external surface of the glass, placed in a cavity with a non-solid solution as seen in a section view to a larger scale of the glass according to the axis (B-B′) or in another alternative according to the axis (D-D′), as well as a section view to a larger scale of the glass, where is placed the electronic module on the glass with the non-solid solution in an alternative according to axis (C-C′);

FIGS. 4, 4.1 and 4.2 represent in a diagrammatic view the integration method of the electronic module in the glass of a watch, with to know, the injection of the non-solid solution with the electronic module in a cavity envisaged for this purpose, a sufficient amount to fill the cavity and finally the glass comprising the electronic module, perfectly integrated thanks to the non-solid solution which is sealed;

FIGS. 5, 5.1 and 5.2 represent in a diagrammatic view the method of application of the electronic module on or under the glass of a watch, namely the application of the non-solid solution with the electronic module on the glass, a proportioning of the non-solid solution according to needs, namely around the module only or about all surface of the glass for example, and finally the perfect marriage of the electronic module with the glass following the vitrification of the non-solid solution.

### DETAILED DESCRIPTION OF POSSIBLE EMBODIMENTS OF THE INVENTION

For reasons of clarity, we decided to define beforehand the terminology used in the present description of a preferential mode of realization with following classification:

1=electronic module or transponder or electronic nano-module

1.1=integrated circuit chip

1.2=antenna

2=cavity/housing

3=watch glass

4=non-solid solution/resins

5=machine/tool

Although the invention is obviously not limited to such a form of realization, the description which follows, is made in the case that the electronic module 1 whose watch glass 3 is equipped with, is planned for to memorize information which relates to the watch itself or which is intended for other applications which are not related to the watch, to be placed at a short distance (of a few millimeters to several centimeters) to a radiating-receiving antenna of a reading and/or writing device, not represented on the drawing, with which it is brought to communicate.

The aforementioned technology of data transmission on which rests on the present invention commonly uses the identification by radio frequency (RFID) which will not be described here, because it forms part of the state of the art and is known for a long time already and largely used in industry.

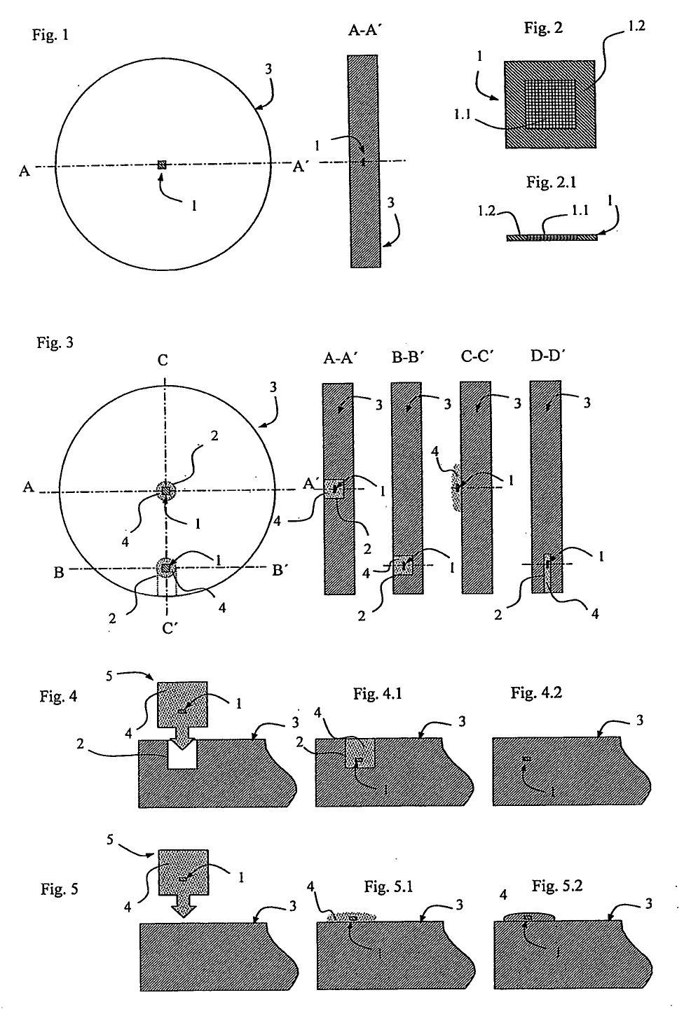

Having said that and by preoccupation with a precision, the watch glass 3 which is represented schematically on FIG. 1 includes/understands as a finished product an electronic module 1 which consists of an integrated circuit chip 1.1 connected to an antenna 1.2 as that is represented schematically with FIG. 2 and FIG. 2.1.

The present form of realization consists in incorporating the electronic module 1 in a resinous organic solution, transparent and liquid 4, at epoxy base, mixed with a hardener or accelerator and chemical agents photo-igniters sensitive to light radiation for to carry out polymerization, and then to inject the whole, as represented schematically on FIG. 4, with the help of a device or of a machine 5, in the small cavity 2 of the watch glass 3 envisaged for this purpose, preferably circular and preferably in the center axis of the watch glass 3, regarding the certain optical advantage which follows from such an emplacement because the center axis of the watch glass 3 is well-known being the least aesthetic point of the watch and hiding at the same time the electronic module 1 so tiny it is, by the center axis of the hands of the watch. But of course other emplacements and housing for the electronic module 1 are possible, such as for example placing the aforementioned electronic module 1 close to the external surface of the glass 3 according to the section view to a larger scale of the glass according to axis (B-B′) or, the cavity 2 is machined in the side face of the glass according to axis (D-D′), offering by there an important advantage, to maintain intact the general aspect, the structural, physical and superficial integrity of the original upper or lower face of the glass 3, thus maintaining the initial resistances of the glass 3 against fractures, cracks, pressures or others external shocks.

Following the injection of the resinous solution 4 including the electronic module 1 in the cavity 2, to see the diagrammatic representation of FIG. 4.1, the aforementioned cavity 2 is presented at a light radiation, in particular with ultraviolet rays, to make harden the resinous solution 4, making the surface treated this way, quickly hard and smooth, comparable with that of the glass 3 of the watch, to see diagrammatic representation of FIG. 4.2, and facilitating the mass production.

Processes of machining such as for example of grinding, of polishing, of engraving, machining by ultrasounds, drilling or abrasion with laser, etc. of the aforesaid cavity 2, as well as the processes of injection or of dispersion of the resinous solution, the composition of the solution 4, not more than suitable machines 5 allowing to implement these processes will not be described because these are processes, manufacturing processes, products and machines known well and also used for a long time in industry, in particular for machining in great series of pieces.

The solution 4 may be composed by other types of liquid or semi-fluid mixture for the filling, compatible with the glass. The essential being that once injected, this solution 4 does mould, harden and integrate itself perfectly in its support which is the glass 3, while protecting thus in an optimal way the electronic module 1, counters any aggression as chemical, mechanical, thermal, electrostatic, magnetic, etc., all in maintaining the same characteristics of optical transparency of the glass 3.

One another alternative of realization, in accordance with FIGS. 5, 5,1 and 5.2, differentiates only by the absence from cavity 2 in the glass 3. The solution including the electronic module 1 coming consequently positioned on the glass 3.

This other alternative of realization consists in incorporating the electronic module 1 in a resinous organic solution, transparent and liquid or gaseous 4, at epoxy base, mixed with a hardener or accelerator and chemical agents photo-igniters sensitive to light radiation for to carry out polymerization, and then to apply the whole, as represented schematically on FIG. 5, with the help of a device or of a suitable machine 5, on the interior or exterior face of the glass 3, and also preferably in the center axis of the glass 3, have regard with the optical advantage described previously. But of course other emplacements on the glass 3 of the watch remain possible.

Following the application of the resinous solution 4 including the electronic module 1 on the glass 3, to see the diagrammatic representation of FIG. 5.1, the part of the glass 3 bearing the resinous solution 4 including the electronic module 1 is presented at a light radiation, in particular with ultraviolet rays, to make harden the resinous solution 4, making the surface treated this way, quickly hard and smooth, comparable with that of the glass 3 of the watch, to see diagrammatic representation of FIG. 5.2, and facilitating the mass production. This other alternative of realization would be appropriate very well for electronic modules 1 that we could entitle electronic nano-modules 1 because extremely small and light, being able even to be fixed with the solution 4 on the glass 3 by a device of vaporization or blowing 5.

Another alternative of realization consists in posing the electronic module 1 on the glass 3 or to introduce it into the cavity 2 and to apply, inject or vaporize 5 thereafter the solution 4 on the aforementioned module 1 or then, to carry out the opposite process, namely to apply, inject or vaporize 5 the solution 4 and to drown there the electronic module 1 thereafter.

It is of course understood that the watch glass 3 which has been ust described according to the mode of realization and its various alternatives, can still undergo others modifications for an optimal integration of the electronic module 1 in the aforementioned glass 3, and by presenting itself there under other alternatives, obvious for the specialist of the profession, without leaving the framework of this invention.

In particular the glass 3 could have another shape than round, and the principal faces could appear with a certain curve. Any material hard and optically transparent, colorless or colored, could be appropriate as watch glass.

Finally the cavities 2 intended to receive the electronic module 1 could deviate from the simple geometrical forms, as the preferential form described in the mode of realization and being carried out in various geometrical forms, and of course by the same one into different dimensions, volumes and depths. Lastly, other developments and applications are also conceivable with regard to the technology of electronic modules 1 which are used in the present invention. One can also note that the classic structure and functionalities of the watch, in particular of the wristwatch, of the watch glass 3, thus of the electronic module 1 were not approached in the present description, insofar as these notions are perfectly known of the specialist of the profession and do not concern directly the subject of this invention.

1. A method for integrating at least one electronic module in the glass of a watch for the memorizing of information, the electronic module being commonly called transponder or tag,
wherein the aforementioned electronic module includes an integrated circuit chip connected to an antenna,
wherein the aforementioned electronic module can communicate by radio signals diffused with a reading and/or writing device,
wherein the aforementioned electronic module is injected, positioned or affixed on or in the glass by means of a liquid, semi-solid or gaseous solution, solution which is intended to solidify and to be fixed with the electronic module inside or outside the glass, and which seals definitively the aforementioned electronic module in or on the glass.

2. The method of claim 1, comprising the step of exposing said non-solid solution and said electronic module to a light radiation, in particular with ultraviolet rays, to make harden quickly the aforementioned solution.

3. The method of claim 1, wherein the non-solid solution is a synthetic or natural resin, an epoxy resin, a gaseous product, or a material with several components.

4. The method of claim 1, wherein said non-solid solution fills completely the cavity.

5. A method for integrating at least one electronic module in the glass of a watch for the memorizing of information, the electronic module being commonly called transponder or tag,
wherein the aforementioned electronic module includes an integrated circuit chip connected to an antenna,
wherein the aforementioned electronic modul can communicate by radio signals diffused with a reading and/or writing device,
wherein the method comprises the successive steps consisting of:
forming by machining in a face of the glass a cavity, intended for to receive the non-solid solution as well as the electronic module and
injecting with the help of a machine or of a tool, the non-solid solution with the electronic module in the cavity and
the non-solid solution seals definitively the electronic module in the glass.

6. The method of claim 5, comprising the step of exposing said non-solid solution and said electronic module to a light radiation, in particular with ultraviolet rays, to make harden quickly the aforementioned solution.

7. The method of claim 5, wherein the non-solid solution is a synthetic or natural resin, an epoxy resin, a gaseous product, or a material with several components.

8. The method of claim 5, wherein said non-solid solution fills completely the cavity.

9. A method for integrating at least one electronic module on the glass of a watch, said electronic module including an integrated circuit chip connected to an antenna for communicating by radio signals with external devices, wherein a non-solid solution including said electronic module is affixed on a face of said glass and seals definitively the aforementioned electronic module on the glass.

10. The method of claim 9, comprising the step of exposing said non-solid solution and said electronic module to a light radiation, in particular with ultraviolet rays, to make harden quickly the aforementioned solution.

11. The method of claim 9, wherein the non-solid solution is a synthetic or natural resin, an epoxy resin, a gaseous product, or a material with several components.

12. The method of claim 9, wherein said non-solid solution fills completely the cavity.

13. A watch glass comprising at least one electronic module for memorizing information,
said electronic module including an integrated circuit chip connected to an antenna for communicating by radio signals diffused with a reading and/or writing device,
the aforementioned electronic module being integrated in the glass with a non-solid solution which seals definitively the aforementioned electronic module in or on the glass.

14. The watch glass of claim 13, in which the electronic module is positioned in the center axis of the glass in order to allow the center axis of the hands of the watch to cover up or to dissimulate the aforementioned electronic module of the glance.

15. The watch glass of claim 13, wherein the cavity that contains the electronic module is machined in the side face of the glass in order to keep intact the general visual aspect, the original structural, physical and superficial integrity of the interior or external face of the glass and to keep intact the initial resistance of the glass against any pressure, fracture, fissure, tension or counters any external shock.

16. A watch glass comprising at least one electronic module for memorizing information,
the aforementioned electronic module being commonly called transponder or tag,
the aforementioned electronic module including an integrated circuit chip connected to an antenna;
the aforementioned electronic module being adapted to communicate by radio signals diffused with a reading and/or writing device,
the aforementioned electronic module being affixed or positioned with the non-solid solution on the glass;
the aforementioned non-solid solution sealing definitively the aforementioned electronic module on the glass.

17. The watch glass of claim 16, wherein the glass is of plastic glass, organic glass, mineral glass, or in crystalline glass such as corundum, sapphire, spinel or diamond.

18. The watch glass of claim 16, in which the electronic module is positioned in the center axis of the glass in order to allow the center axis of the hands of the watch to cover up or to dissimulate the aforementioned electronic module of the glance.

19. The watch glass of claim 16, wherein the cavity that contains the electronic module is machined in the side face of the glass in order to keep intact the general visual aspect, the original structural, physical and superficial integrity of the interior or external face of the glass and to keep intact the initial resistance of the glass against any pressure, fracture, fissure, tension or counters any external shock.

20. A watch, in particular a wristwatch comprising a watch glass,
said watch glass containing at least one electronic module for the memorizing of information,
said electronic module comprising an integrated circuit chip connected to an antenna,
said electronic module being affixed or positioned with a non-solid solution to the glass, or being integrated in the glass with a non-solid solution which seals definitively the aforementioned electronic module in or on the glass.

21. A method for integrating at least one electronic module in or on the glass of a watch for the memorizing of information,
wherein said electronic module is put on the glass or is introduced into the cavity,
wherein a solution is applied, injected or vaporized thereafter on the aforementioned module,
wherein said solution seals definitively the aforementioned electronic module in or on the glass.

22. A method for integrating at least one electronic module in or on the glass of a watch for the memorizing of information, comprising the steps of:
positioning, injecting or vaporizing a solution on the glass or in the cavity,
drowning the electronic module thereafter in the solution which seals definitively the aforementioned electronic module in or on the glass.
